(19) United States
(12) Patent Application Publication
(10) Pub. No.: US 2026/0245417 A1
(43) Pub. Date: Aug. 20, 2026

(54) DOOR OPENER WITH ABILITY TO ERASE OR DEACTIVATE INDIVIDUAL REMOTE ACTUATORS FROM A CONTROL LIST

(71) Applicant: ASSA ABLOY Entrance Systems AB, Landskrona (SE)

(72) Inventors: Vickie LENTS, Winston-Salem, NC (US); David P. BRESSON, Pfafftown, NC (US); Davide BRAGGION, Milan (IT); Juan Jorge LLORET MADRID, Noventa Padovana (IT)

(21) Appl. No.: 19/056,894

(22) Filed: Feb. 19, 2025

(51) Int. Cl. G07C 9/10

(52) U.S. Cl. CPC G07C 9/10

(57) ABSTRACT

A system for operating a movable barrier may include an opener and an administration device. The opener may be operably coupled to the movable barrier to transition the movable barrier between open and closed positions. The opener may include a receiver configured to receive a transmitted signal from a remote transmitter, and a controller including first processing circuitry configured to determine whether the transmitted signal is from an authorized remote operator by comparing a code in the transmitted signal to a list of codes in an authorized remote actuator list and activate the motor in response to the transmitted signal being determined to be from the authorized remote actuator list. The administration device may include second processing circuitry configured to enable communication with the controller. The controller is further configured to delete an individual code from the authorized remote actuator list responsive to an instruction from the administration device.

### TECHNICAL FIELD

Example embodiments generally relate to devices for automated operation of movable barriers, such as sectional garage doors and, in particular, relate to an opener for such a movable barrier that has the ability to erase or deactivate individual previously authorized remote actuators from a control list.

### BACKGROUND

Moveable barriers including sectional doors, such as garage doors, are commonly used to partition or enclose spaces. Just as commonly, an automated opening device is connected to the sectional doors in order to easily and remotely open or close the doors. As an example, a large portion of sectional doors for both residential and industrial applications employ an installed garage door opener (GDO) to automatically open and close the sectional doors based on the actuation of a local or remote actuator (that is often simply referred to as a “remote” or “remote control”) that causes an operator or motor to operate to move the movable barrier when actuated.

In a typical situation, the user is physically present when the local actuator is used, and the actuation may occur responsive to a wired connection, or via a short range wireless connection, between the local actuator and the operator. When the remote actuator is used, the remote actuator is typically in a vehicle of the user, or sometimes carried on the person of the user, and uses wireless connections that are capable of communication at greater ranges (e.g., a few houses away down the street). In this regard, a receiver at the operator “listens” for transmissions from the remote actuator and, when a transmission is received from a recognized and authorized remote actuator, the operator triggers operation of the motor or operator to move the movable barrier. Within this context, the term “listen” refers to the process of receiving transmissions at an antenna and evaluating such transmissions to determine whether the transmissions have a particular characteristic in terms of signal strength, quality, or other parameters that may be of interest.

Many GDO products allow the addition of remote actuators so that the user can have the convenience of not needing to move a limited number of remote actuators to various different use contexts. For example, each vehicle, each family member, each worker, or each user in various other situations where a multiplicity of users are desired, may possess a remote actuator, and the remote actuator may be authorized and able to actuate the operator from a distance. For larger families, businesses, condominiums with shared parking space, or certain other private parking options where a number of users are given access, the number of remotes that are issued can grow to be large.

The authorization of a particular remote actuator for interaction and communication with the operator is typically accomplished via a well-known process that is typically referred to as “pairing.” The pairing process is often entered by pressing a button on the operator itself, or more recently also via interaction via a smart phone application (or “app”) responsive to authentication of the user. When pairing is initiated, a controller of the operator enters a mode in which the receiver of the operator is used to scan for transmissions from a new remote actuator. Whereas outside the pairing mode, only previously paired devices may cause actuation of the operator, while in the pairing mode, new or previously unrecognized remote actuators can be recognized as being authorized to operate the GDO and move the movable barrier remotely. The new remote actuator(s) may then be added to a list of authorized remote actuators that can actuate the GDO thereafter outside the pairing mode. This list may be referred to as an authorized remote actuator list or, more simply, a control list.

A problem that can be encountered in the context above occurs when a single one (or more) of the remote actuators on the control list becomes lost or stolen. The lost or stolen remote actuator represents a security risk until it is recovered since, regardless of its possessor's identity, it retains the ability to operate the GDO. In the past, it has generally not been possible to delete individual remote operators from the control list. Accordingly, it would be desirable to provide a technical solution to the problem noted above.

### BRIEF SUMMARY OF SOME EXAMPLES

In an example embodiment, a system for operating a movable barrier may be provided. The system may include an opener and an administration device. The opener may be operably coupled to the movable barrier to transition the movable barrier between an open position and a closed position. The opener may include a receiver configured to receive a transmitted signal from a remote transmitter, and a controller including a first processing circuitry configured to determine whether the transmitted signal is from an authorized remote operator by comparing a code in the transmitted signal to a list of codes in an authorized remote actuator list and activate the motor in response to the transmitted signal being determined to be from the authorized remote actuator list. The administration device may include a second processing circuitry configured to enable communication with the controller. The controller is further configured to delete an individual code from the authorized remote actuator list responsive to an instruction from the administration device.

In another example embodiment, a remotely operable movable barrier opener may be provided. The opener may include a motor operable to transition the movable barrier between an open position and a closed position, a receiver configured to receive a transmitted signal from a remote transmitter, and a controller including processing circuitry configured to determine whether the transmitted signal is from an authorized remote operator by comparing a code in the transmitted signal to a list of codes in an authorized remote actuator list and activate the motor in response to the transmitted signal being determined to be from the authorized remote actuator list. The controller may be further configured to delete an individual code from the authorized remote actuator list responsive to an instruction from an administration device in communication with the controller.

In another example embodiment, a, administration device may be provided. The administration device may include a user interface, a wireless communication module communicatively operably coupling the administration device to a controller of an opener of a movable barrier, and processing circuitry configured to provide an instruction to the controller to delete an individual code from an authorized remote actuator list stored at the controller responsive to identification of a selected remote actuator from a control list stored at the administration device and provide a deletion option presented at the user interface.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a door opener system in a ceiling mounted or trolley configuration in accordance with an example embodiment;

FIG. 2 illustrates a block diagram of such a system configured to allow individual deletion of remote actuators from an authorized remote actuator list in accordance with an example embodiment;

FIG. 3 illustrates a block diagram of an administration device for enabling individual deletion of remote actuators from an authorized remote actuator list in accordance with an example embodiment;

FIG. 4 illustrates an example of a user interface screen that may be used to modify a control list in accordance with an example embodiment;

FIG. 5 illustrates an example of a control list after modification in accordance with an example embodiment; and

FIG. 6 illustrates an example presentation of activity information in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

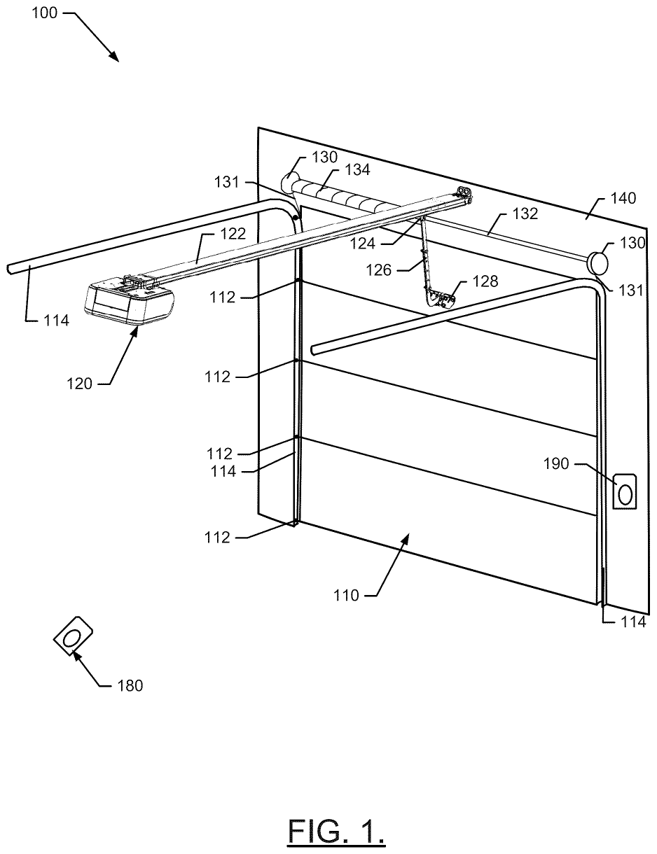

As indicated above, loss of a remote actuator can represent a security risk for an enclosed space to which access is restricted via a movable barrier operated by an opener that operates responsive to the remote actuator. As further noted above, it would be desirable to be able to remove individual remote actuators from the control list when such devices are either lost or stolen (or otherwise preferred for removal for any reason). The typical problem that prevents this is that the opener itself, within its authorized remote actuator list, simply records a listing of authorized codes. The codes are generally unknown to the possessors of each of the devices that have the respective codes. Thus, what generally exists inside the opener is a list of coded information that is not readable or discernable by humans, so that there is virtually no way to identify which specific remote actuator should be removed from the list. Example embodiments address the problem by providing a new paradigm for maintaining and interacting with the authorized remote actuator list via an administration device (e.g., a smart phone application (or app), or other computer application) that can interact with the controller of the opener to identify and enable erasing or deletion of specifically identified, including individual, remote actuators from the control list. FIG. 1 illustrate a system in which example embodiments may be employed.

More particularly, FIG. 1 illustrates a garage door operator (GDO) system 100 of an example embodiment. In this regard, FIG. 1 shows the GDO system 100 in a trolley (or ceiling mounted) configuration, but it should be understood that example embodiments may also apply to situations in which the GDO system 100 is in a jackshaft configuration. In both cases, the GDO system 100 includes a sectional door 110, in which each section of the door has rollers 112 operably coupled to opposing lateral sides of the sections. The rollers 112 are typically rotatably operably coupled to the sectional door 110 via brackets that rotatably support a shaft of the rollers 112 and enable a wheel to extend into and ride within rails 114 disposed on opposing sides of the sectional door 110 as the sectional door 110 transitions between open and closed positions. The sectional door 110 of FIG. 1 is shown in the closed position, where the rollers 112 are in a vertical section of the rails 114. Thus, it can be appreciated that in the open position the rollers 112 are located in a horizontally extending portion of the rails 114, and the sectional door 110 is carried into parallel with the ground as opposed to its condition of being perpendicular to the ground in the closed position shown in FIG. 1. Each section of the sectional door 110 can pivot relative to any adjacent section at an intersection thereof in order to enable the sectional door 110 to traverse the bend that separates the horizontally extending portion of the rails 114 from the vertically extending portion of the rails 114.

FIG. 1 also illustrates a GDO unit referred to as an opener 120 or motorhead. The opener 120 of this example is shown in the trolley configuration in which a guide rail 122 may extend parallel to and approximately midway between the horizontally extending portion of the rails 114 on opposing lateral sides of the sectional door 110. The opener 120 may be mounted (e.g., from the ceiling) proximate to an end of the guide rail 122 to drive a trolley 124 along the guide rail 122 via a flexible member such as a belt, cable or chain. In particular, the flexible member may be driven and moved responsive to operation of an operator such as an electric motor. The belt, cable or chain may also be operably coupled (e.g., via the trolley 124) to a top portion of the sectional door 110 by an engaging arm 126 and engaging bracket 128 that is attached to the sectional door 110. As noted above, the trolley 124 may be manually released from the sectional door 110 to allow for manual repositioning of the sectional door 110.

In some cases, the sectional door 110 may also be supported by one or more instances of cables 131 that are alternately wound onto and off of one or more cable drums 130 disposed at or near opposing ends of a tube 132 (sometimes called a drive tube). The cables 131 may be attached to a bottom portion of the sectional door 110 to assist in carrying the weight of the sectional door 110. The tube 132 may further support a spring assembly 134 that facilitates, along with the cables 131, supporting the weight of the sectional door 110 during opening and closing operations of the sectional door 110 using the opener 120. The sectional door 110, when closed, may block an opening provided in a front wall 140 of the garage in which the GDO system 100 is installed. The opening may be left open when the sectional door 110 is raised onto the horizontally extending portions of the rails 114. As can be seen in FIG. 1, the guide rail 122 may be secured to the front wall 140 at a proximal end of the guide rail 122, and the opener 120 may be suspended from the ceiling of the garage at a distal end of the guide rail 122.

The sectional door 110 is, as noted above, often comprised of panels of aluminum, steel, fiberglass, plastic, or other relatively lightweight, but otherwise structurally rigid material of any suitable type. In some cases, one or more of the panels of the sectional door 110 may include or be comprised of a glass or film that may be transparent or translucent to allow natural light to pass therethrough and into the garage or other space to which the sectional door 110 provides access. The opener 120 draws power, typically from an alternating current (AC) mains power supply, which may be accessed by corded connection to a power supply outlet.

The opener 120 may be actuated by one or more instances of an actuator, which may include a movable actuator (e.g., remote actuator 180) and a fixed actuator 190, which may be mounted on a wall or at the opener 120. Notably, although the fixed actuator 190 of FIG. 1 is located at the front wall, the fixed actuator 190 may alternatively be located at a back wall or any sidewall of the garage (or other location in which the operator system is employed). The remote actuator 180 may be located in a vehicle, or may be carried by the user, or otherwise be movable and usable when within range of the opener 120 to wirelessly instruct the opener 120 to operate to open or close the sectional door 110. The fixed actuator 190 and/or the remote actuator 180 may include a simple button or other actuator to operate the opener 120. However, in other examples, the fixed actuator 190 and/or remote actuator 180 may include a display (e.g., touch screen display) or other more complicated user interface to enable control of the opener 120 in addition to other functions associated with operation, monitoring or control of the GDO system 100.

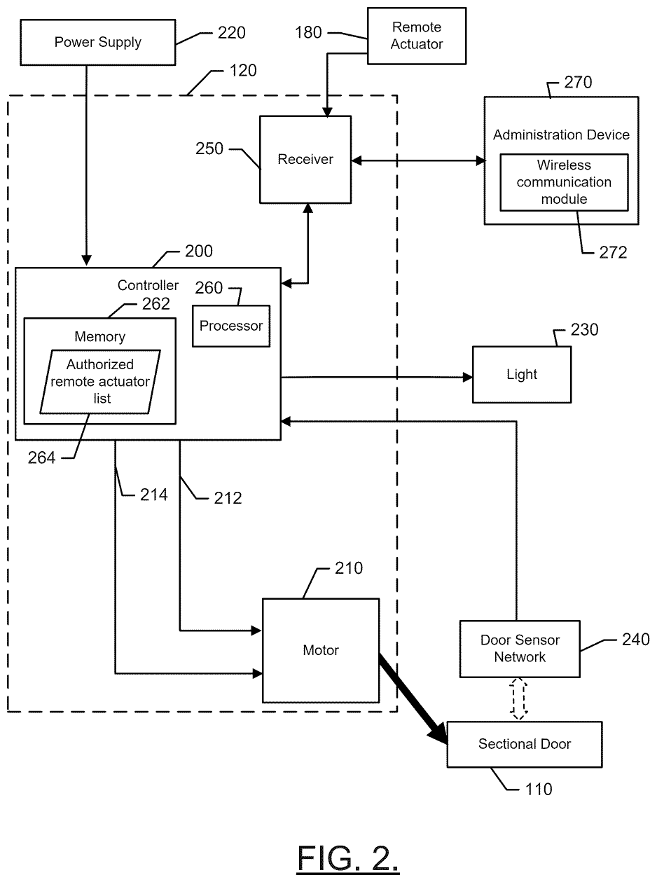

As noted above, the remote actuator 180 may be paired with the opener 120 via a pairing process, and may be one of potentially multiple remote actuators that may be paired with the opener 120 and therefore authorized to actuate the opener 120. The opener 120 of example embodiments may be modified as described herein to enable individual management of the addition and deletion of remote actuators, and FIG. 2 is aimed at defining an example context in which such modification may be accomplished. Notably, the sectional door 110 is merely one example of a movable barrier upon which the opener 120 may operate. In other embodiments, gates, doors, partitions and barriers of other types may also be operated by respective other instances of the opener 120. In such cases, to the extent remote actuators are paired with the opener 120, the management of addition and/or removal of the remote actuators from a control list may be accomplished as described herein.

Turning to FIG. 2, a block diagram of various components of a GDO system of an example embodiment is shown. In particular, various internal components of the opener 120 of FIG. 1 are shown. However, the GDO system and its movement of the sectional door 110 should be remembered to be simply one example system in which a movable barrier is moved responsive to actuation from the remote actuator 180 where the remote actuator 180 is an authorized actuator for the opener 120 via a pairing process. In an example embodiment, the opener 120 may include a controller 200 and a motor 210. The motor 210 may operate under control of the controller 200, which may receive power from a power supply 220 (e.g., mains power), and may regulate the provision of power to the motor 210 to control both the operation of the motor 210 and the direction of the operation (e.g., closing or opening). In some cases, the controller 200 may provide separate power to the windings of the motor 210 for forward (e.g., closing) and reverse (e.g., opening) directions of operation, and such power may be provided as a forward power connection 212 and a reverse power connection 214.

In an example embodiment, the controller 200 may also selectively provide power to a light 230. In some cases, the light 230 may be a general space illumination device that illuminates surrounding areas whenever the motor 210 operates (and for some period thereafter, or when otherwise turned on via the controller 200). However, the light 230 may also or alternatively be used to indicate a current mode or provide information regarding progress or completion of steps or operations of a process associated with the current mode. For example, the light 230 may flash according to a given pattern to indicate that the opener 120 is in the pairing mode, or the light 230 may flash to indicate that inputs are received or not received, or that steps are completed or not completed, in association with performance of the pairing process while in the pairing mode.

In an example embodiment, a door sensor network 240 may be disposed on or proximate to the sectional door 110 to monitor aspects of the movement of the sectional door 110 and/or its environment. The door sensor network 240 may include motion, speed, force and other sensors associated with movement of the sectional door 110 including, for example, limit switches that determine respective limits for motion of the sectional door 110 in both the opening and closing directions. Moreover, the door sensor network 240 may also include an obstruction sensor, which may detect when an object is between the sectional door 110 and the ground beneath the sectional door 110 to ensure that the sectional door 110 does not close on the object. In some cases, the obstruction sensor may include an infrared or other beam emitter, and a corresponding beam receiver that provides an input to the controller 200 to indicate that the beam emitted by the beam emitter is not being received at the beam receiver (e.g. due to the object, or misalignment of the emitter and receiver). When the controller 200 receives the input from the obstruction sensor, the controller 200 stops provision of power to the motor 210 to stop movement of the motor 210. Similarly, when the limit switches are triggered, the controller 200 is informed and stops movement of the motor 210, which in most cases simply means stopping the provision of power via both the forward and reverse power connections 212 and 214.

In an example embodiment, the controller 200 may be operable responsive to input from the remote actuator 180, as discussed above in general terms. However, more specifically, the remote actuator 180 may transmit a signal at a particular frequency that is generally within a band of frequencies to which a receiver 250 of the opener 120 is tuned. In some embodiments, the remote actuator 180 may further generate a code in or via its transmitted signal, and the code may uniquely identify the remote actuator 180. The controller 200 may include processing circuitry that is configured to control the operation of the opener 120. In this regard, for example, the processing circuitry may include a processor 260 and memory 262. The memory 262 may store data, applications (e.g., for execution by the processor 260) or any other suitable information for local or remote usage consistent with the descriptions provided herein. In some cases, the processing circuitry may be part of a printed circuit board (PCB), application specific integrated circuit (ASIC) or other integrated circuit (IC) chip, board or the like. The processing circuitry may therefore, depending on its configuration (e.g., via hardware, firmware and/or software) enable the controller 200 to execute coordinated control over the motor 210 responsive to actuation from authorized sources, which may include any remote actuators having a code that has been previously learned, and thereafter stored in the memory 262. In some cases, the learned or stored codes may form or be considered to form an authorized remote actuator list 264. Thus, for example, whenever the receiver 250 receives a transmission in the band of frequencies to which the receiver 250 is generally tuned and therefor sensitive, the code of the transmission received may be checked against the authorized remote actuator list 264. If the code of the transmission received matches one of the codes in the authorized remote actuator list 264, the controller 200 may actuate the motor 210 to open or close the sectional door 110. If the code of the transmission received does not match one of the codes in the authorized remote actuator list 264, no action may be taken and the motor 210 is not operated.

As can be appreciated from the discussion above, when the opener 120 is placed in the pairing mode (or learning mode), the controller 200 enables transmissions with new codes to be added to the authorized remote actuator list 264. In this regard, when the controller 200 places the opener 120 in the pairing mode (e.g., via selection of a button commanding transition to the pairing mode locally at the opener 120, or via instructions received via an app), if the code of the transmission received does not match one of the codes in the authorized remote actuator list 264, the code is added to the authorized remote actuator list 264.

As noted above, the authorized remote actuator list 264 is often (or may be in any case) a listing of codes that are authorized to, when received by the controller 200, trigger actuation of the motor 210 to open or close the sectional door 110. Each individual code in the listing of codes of the authorized remote actuator list 264 is typically stored without any other identifying information associated with the remote actuator 180 to which it corresponds. Thus, as noted above, there is typically no way to identify a single one of the codes for deletion after the codes are added to the authorized remote actuator list 264. Example embodiments may enable the identification of a single one of the codes (or more) for deletion. In particular, in some cases, example embodiments may provide for an interaction with the authorized remote actuator list 264 via an administration device 270. The administration device 270 may provide means by which to identify individual remote actuators for a user, and further enable coordination of and management of the addition and/or deletion remote actuators on an individual basis to/from the authorized remote actuator list 264.

In an example embodiment, the administration device 270 may be communicatively coupled to the controller 200 (e.g., via wireless communication enabled by the receiver 250 and a wireless communication module 272 of the administration device 270) to provide instructions to delete one or more remote actuators from the authorized remote actuator list 264 on an individually identified basis. In other words, although more than one remote actuator can be deleted, the deletion is specifically on the basis of identifying a code to be deleted, and not based on a mere mass deletion of all codes.

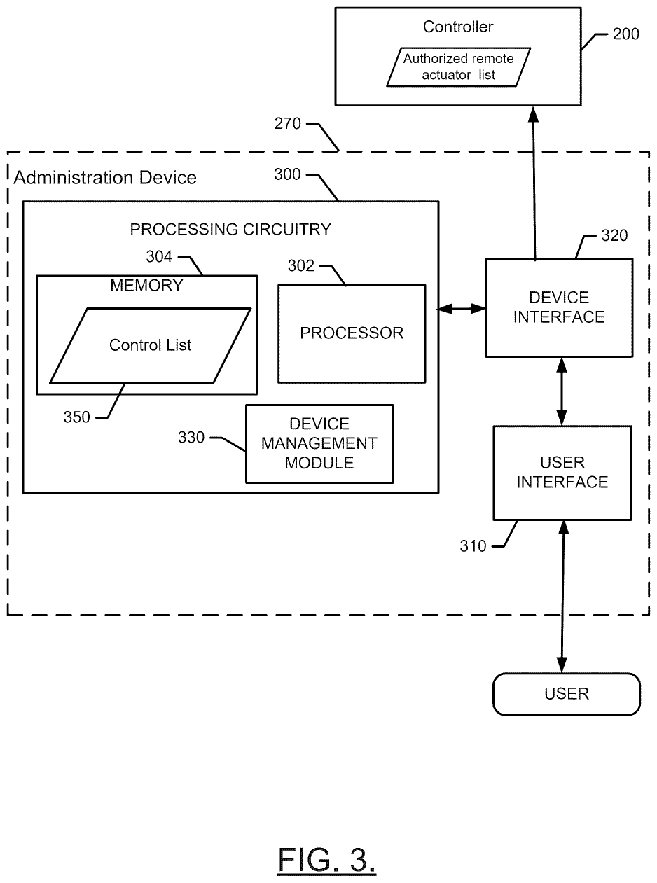

Although this may be accomplished in multiple ways, an example embodiment will be described in relation to FIG. 3, which shows a block diagram of the administration device 270 of an example embodiment. Referring now to FIG. 3, the administration device 270 may include or otherwise be in communication with processing circuitry 300 that is configured to perform data processing, application execution and other processing and management services according to an example embodiment of the present invention. In one embodiment, the processing circuitry 300 may include a storage device (e.g., memory 304) and a processor 302 that may be in communication with or otherwise control a user interface 310 and a device interface 320. As such, the processing circuitry 300 may be embodied as a circuit chip (e.g., an integrated circuit chip) configured (e.g., with hardware, software or a combination of hardware and software) to perform operations described herein. However, in some embodiments, the processing circuitry 300 may be embodied as a portion of a server, computer, laptop, workstation or even one of various mobile computing devices such as a tablet or smart phone. In situations where the processing circuitry 300 is embodied as a server or at a remotely located computing device, the user interface 310 may be disposed at another device (e.g., at a computer terminal) that may be in communication with the processing circuitry 300 via the device interface 320.

The user interface 310 may be in communication with the processing circuitry 300 to receive an indication of a user input at the user interface 310 and/or to provide an audible, visual, mechanical or other output to the user. As such, the user interface 310 may include, for example, a keyboard, a mouse, a joystick, a display, a touch screen, a microphone, a speaker, augmented/virtual reality device, or other input/output mechanisms.

The device interface 320 may include one or more interface mechanisms for enabling communication with other devices and/or networks. In some cases, the device interface 320 may be any means such as a device or circuitry embodied in either hardware, software, or a combination of hardware and software that is configured to receive and/or transmit data from/to the controller 200 of the opener 120 (e.g., via receiver 250 or another communication interface that may be wired or wireless) and/or any other device or module in communication with the processing circuitry 300. In this regard, the device interface 320 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 320 communicates with a network to which the controller 200 may be communicatively coupled, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the memory 304 may include one or more non-transitory storage or memory devices such as, for example, volatile and/or non-volatile memory that may be either fixed or removable. The memory 304 may be configured to store information, data, applications, instructions or the like for enabling the apparatus to carry out various functions in accordance with example embodiments of the present invention. For example, the memory 304 could be configured to buffer input data for processing by the processor 302. Additionally or alternatively, the memory 304 could be configured to store instructions for execution by the processor 302. As yet another alternative, the memory 304 may include one of a plurality of databases (e.g., database server) that may store a variety of files, contents or data sets. Among the contents of the memory 304, applications (e.g., a service application configured to interface with the client application 22) may be stored for execution by the processor 102 in order to carry out the functionality associated with each respective application.

The processor 302 may be embodied in a number of different ways. For example, the processor 302 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 302 may be configured to execute instructions stored in the memory 304 or otherwise accessible to the processor 302. As such, whether configured by hardware or software methods, or by a combination thereof, the processor 302 may represent an entity (e.g., physically embodied in circuitry) capable of performing operations according to embodiments of the present invention while configured accordingly. Thus, for example, when the processor 302 is embodied as an ASIC, FPGA or the like, the processor 302 may be specifically configured hardware for conducting the operations described herein. Alternatively, as another example, when the processor 302 is embodied as an executor of software instructions, the instructions may specifically configure the processor 302 to perform the operations described herein.

In an example embodiment, the processor 302 (or the processing circuitry 300) may be embodied as, include or otherwise control various operations of the administration device 270, which may be any means such as a device or circuitry operating in accordance with software or otherwise embodied in hardware or a combination of hardware and software (e.g., processor 302 operating under software control, the processor 302 embodied as an ASIC or FPGA specifically configured to perform the operations described herein, or a combination thereof) thereby configuring the device or circuitry to perform the corresponding functions of the administration device 270 as described below.

The administration device 270 may be a mobile or fixed computing device such as a computer, tablet, smartphone, or other such device via which a user may interact with the opener 120 (e.g., via the controller 200). Thus, for example, the administration device 270 may be configured to provide tools to facilitate the creation of customer or user accounts (and in some cases also a corresponding user profile), and the coordination of communication and control instructions for the opener 120 as described herein. The tools may be provided in the form of various modules that may be instantiated by configuration of the processing circuitry 300. FIG. 3 illustrates one example of a module that may be included in the administration device 270 and that may be individually configured to perform one or more of the individual tasks or functions generally attributable to the administration device 270 according to an example embodiment. However, the administration device 270 need not necessarily be modular. In cases where the administration device 270 employs modules, the modules may, for example, be configured to perform the tasks and functions described herein. In some embodiments, the administration device 270 and/or any modules comprising the administration device 270 may be any means such as a device or circuitry operating in accordance with software or otherwise embodied in hardware or a combination of hardware and software (e.g., processor 302 operating under software control, the processor 302 embodied as an ASIC or FPGA specifically configured to perform the operations described herein, or a combination thereof) thereby configuring the device or circuitry to perform the corresponding functions of the administration device 270 and/or any modules thereof, as described herein.

The example module of FIG. 3 may be referred to as a device management module 330, which may be configured to enforce data security and data/user access control among other things. In some example embodiments, the device management module 330 may employ authentication and authorization tools to manage the provision of access to multiple authorized users or to a single administrator based on the provision of authorized credentials prior to granting access to the functions of the device management module 330. The device management module 330 may be configured to manage storage of and access to information about operations of the opener 120, which may include descriptive information about settings, approvals, or management paradigms that apply to specific users or remote actuators. The device management module 330 may also manage the recording of activity details associated with usage of the opener 120 by individual remote actuators in the memory 304 including details regarding which remote actuator was used at a given time to open or close the sectional door 110 via the opener 120. Various other data may also be recorded.

In an example embodiment, the device management module 330 may handle communications with the controller 200 of the opener 120 associated with maintaining the authorized remote actuator list 264 and, more specifically, associated with enabling the authorized remote actuator list 264 to be interacted with on a basis that permits individual remote actuator management including deletion of individual remote actuators. To accomplish this, the device management module 330 may maintain locally thereat (e.g., stored in memory 304) a control list 350, which may share some of the basic information of the authorized remote actuator list 264, but which may also store much more information, which can be managed by authorized users (or the manager) via the administration device 270. In this regard, for example, the control list 350 may store all of the codes of the authorized remote actuators (e.g., previously paired or learned codes) that are stored in the authorized remote actuator list 264, but may further store additional information for distinguishing the respective identities of each one of the remote actuators so that management can occur on an individual basis.

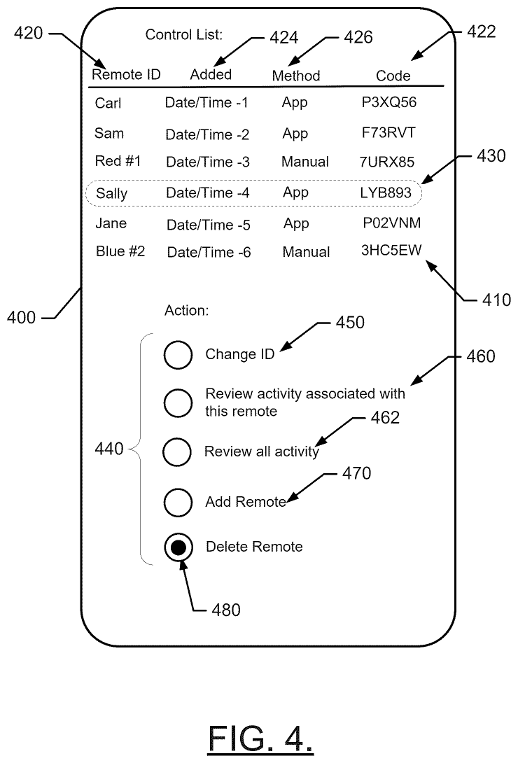

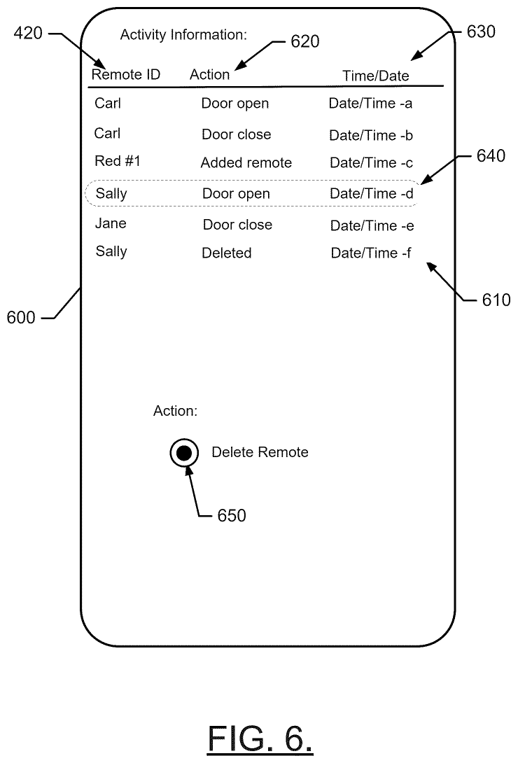

The user interface 310 may provide one or more display screens, control consoles, or other interface elements to enable the user (or manager) to interact with the control list 350. Changes made to the control list 350 may then be synchronized with the authorized remote actuator list 264 through communication with the controller 200. Such synchronization may also occur in reverse in that any changes made to the authorized remote actuator list 264 at the opener 120 may be communicated to the administration device 270 for corresponding updating of the control list 350. The synchronizations may occur periodically or on an event-driven basis. Event-driven synchronization may occur, for example, whenever signaling between the opener 120 and administration device 270 indicates that a change has been made to either one of the control list 350 or the authorized remote actuator list 264. Some examples for how the user interface 310 may be involved in synchronization and other actions taken involving the administration device 270 will be described below in reference to FIGS. 4-6.

Turning first to FIG. 4, a display screen 400 is shown, which may appear on a smartphone app when the administration device 270 is embodied as a smartphone. However, it should be appreciated that a similar interface may be provided on a tablet or other computer as well. The display screen 400 is presently displaying an example control list 410, which includes a plurality of authorized remote actuators. The control list 410 is provided in a tabular format that shows authorized remote actuators listed by row, and columns are provided to indicate specific information associated with each individual one of the authorized remote actuators. In this regard, for example, one column may be a remote identifier column 420, which may list a name, color, or any other suitable identifier for each individual one of the authorized remote actuators. In the example shown in FIG. 4, several of the individual ones of the authorized remote actuators are identified by the name of the person who has been issued or is otherwise associated with the respective remote actuators, and a couple of the authorized remote actuators are identified by a color, which may presumably be a color of the physical device itself. Any other suitable identification means may also be used. For example, the vehicle model or nickname of the vehicle in which the corresponding remote actuator is typically maintained may be used, or any other desired naming convention that the user (or manager) chooses to employ.

The control list 410 may also include a column for representation of the code 422 of each one of the authorized remote actuators. The code 422 may be the same code that is actually stored in the authorized remote actuator list 264 at the opener 120. However, as noted above, that code stored at the authorized remote actuator list 264 is typically not otherwise readily identifiable as being associated with any particular identity of a person, location, or other distinguishing characteristic. Thus, the control list 410 provides a tie between identity and code so that management of individual remote actuators may be accomplished as described herein.

In an example embodiment, the control list 410 may not need to include any other information beyond some identifying information (e.g., the remote identifier in the remote identifier column 420) and each respective instance of the code 422. However, other information may be provided in some cases. For example, a listing of the date and/or time that each individual remote actuator was authorized or added to the control list 410 and/or the authorized remote actuator list 264 may be provided in a time added column 424. The method by which the individual remote actuator was authorized or added may also be shown in a method column 426. In some cases, the administration device 270 (and particularly the app that is operable thereat) may be used to initiate pairing or learning of new remote actuators. Any remote actuator that is authorized and added by this means may be indicated as such in the method column 426 (e.g., by indicating that the “app” method was used). Similarly, any remote actuator that is authorized and added via direct interaction with the opener 120 may be indicated as such in the method column 426 (e.g., via indicating that the “manual” method was used). If any other means of adding remote actuators to the control list 410 or the authorized remote actuator list 264 exist, those other means may also be distinguished by respective descriptive titles in the method column 426.

The user (or manager) may select one of the remote actuators from the control list 410 as a selected remote actuator 430. In FIG. 4, the selected remote actuator 430 is highlighted by a dashed outline. However, any suitable highlighting or selecting method may be used to indicate which one of the remote actuators in the control list 410 is selected as the selected remote actuator 430. In some cases, an actions list 440 may be provided to indicate actions that can be taken with respect to the control list 410. The actions list 440 may include, for example, a change identity option 450, which may be used to change the remote identifier of the selected remote actuator 430. In this regard, for example, the selected remote actuator 430 of FIG. 4 has a remote identifier of “Sally”. Presumably, an individual named Sally may have been in possession of the selected remote actuator 430. By selecting the change identity option 450, the user (or manager) may be able to change the remote identifier from “Sally” to the name of another person who is given possession of the remote actuator that used to be possessed by Sally.

In some cases, another action from the actions list 440 may be a remote-specific data review option 460. The remote-specific data review option 460 may enable the user (or manager) to see all activity initiated via the selected remote actuator 430. Thus, for example, all door opening or closing requests initiated via the selected remote actuator 430 may be reviewed. Due to memory limitations, the data may be limited to a given number of cycles or a given period of time. However, in some cases, each and every actuation of the actions initiated by the selected remote actuator 430 may be stored and reviewable. Additionally, in some cases it may be possible to review all activity regardless of which remote actuator initiated the activity. Global data review option 462 may be selected to review all events generated in association with operation of the opener 120, and FIG. 7 illustrates an example of an interface screen generated to permit such a review.

In an example embodiment, the administration device 270 may be used to manage the addition of new remote actuators to the control list 410 (and also the authorized remote actuator list 264). In other words, the administration device 270 may itself be able to transition the opener 120 into a pairing or learning mode so that a new code can be learned and added to the authorized remote actuator list 264 for a remote actuator being also added to the control list 410 along with its corresponding remote identity information and the other data shown in the control list 410 of FIG. 4. Accordingly, an add remote option 470 may be included in the actions list 440.

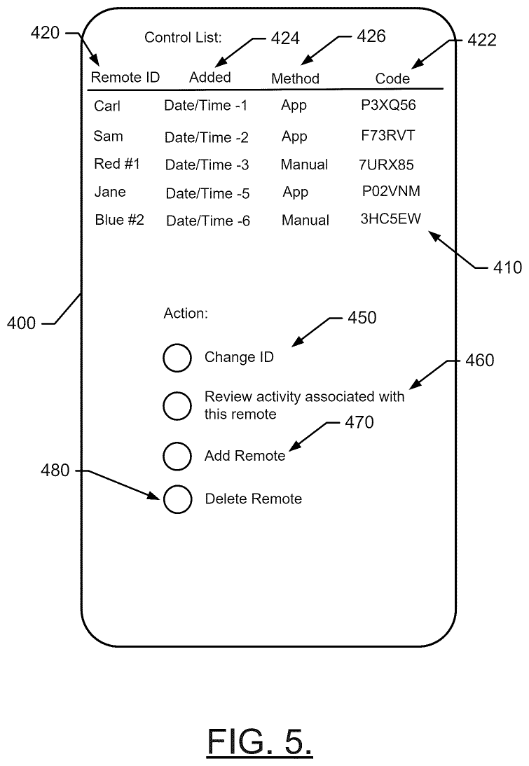

The administration device 270 may also manage the removal of individual remote actuators from the control list 410 and also from the authorized remote actuator list 264 via a delete remote option 480, which may also be included in the actions list 440. In this regard, as shown in FIG. 4, if the selected remote actuator 430 is then further selected for deletion via the delete remote option 480, then the transition shown in FIG. 5 may occur in that the selected remote actuator 430 may be removed from the control list 410. The administration device 270 may then synchronize the control list 410 with the authorized remote actuator list 264 at the controller 200 in order to identify the selected remote actuator 430 by its code 422 to have the corresponding remote actuator code removed from the authorized remote actuator list 264. Any subsequent transmissions received at the opener 120 from the selected remote actuator 430 will not be able to operate the opener 120. This process can be repeated for any individual one of the remote actuators in the control list 410. Moreover, in some cases, multiple ones of the remote actuators in the control list 410 may be simultaneously selected as selected remote actuators, and the corresponding multiple selected remote actuators may then be deleted simultaneously by the delete remote option 480.

Although the example described above involves the maintenance and synchronization of two lists of authorized remote actuators (i.e., one at the administration device 270 and one at the opener 120), it is also possible that only a single control list may be maintained at the opener 120, and the administration device 270 may merely provide the interface means by which to interact with that single control list. Example embodiments may therefore prevent any need to delete an entire control list when a single remote actuator is lost or stolen. Example embodiments may also enable easy access to robust information about activity associated with individual remote actuators, as well as a simple and intuitive interface for managing the use and issuance of multiple remote actuators to various users.

Although deletion may be accomplished by picking a remote actuator to delete based on its identity using the method described above, this is not the only means for deletion. In this regard, in the example above, it may be known that Sally's remote actuator has been lost or stolen due to the occurrence being specifically reported as such. However, in some cases, the identity of the lost or stolen remote actuator may not be reported. Instead, the fact of a lost or stolen remote actuator may be evidenced by an undesired actuation of the sectional door 110. Example embodiments therefore also use the global data review option 462 to enable the user (or manager) to see all activity initiated via the selected remote actuator 430 as shown in FIG. 7.

In the example of FIG. 7, the global activity list shows an open and close cycle initiated by Carl's remote followed by the addition of a new remote (i.e., Red #1). Thereafter, a door open operation is initiated using Sally's remote that is not followed by a closing cycle. Jane may notice the suspicious door opening, and close the door and report the suspicious activity. Thereafter, the user (or manager) may review the activity information 600 shown on FIG. 7. All of the remote actuators that have been active are listed in the remote identifier column 420 along with the corresponding activity list 610, which shows an action column 620 and a time/date column 630 for listing what action was taken and when, respectively, for each acting remote actuator as corresponding event entries. The user (or manager) can see the potential unauthorized or suspicious activity reported, and highlight the corresponding event entry from the activity information 600 and selecting a deletion option 650 to delete the corresponding remote actuator from the control list 410 and the authorized remote actuator list 264.

Accordingly, example embodiments may provide a system for operating a movable barrier that enables individual remote actuator deletion. The system may include an opener and an administration device. The opener may be operably coupled to the movable barrier to transition the movable barrier between an open position and a closed position. The opener may include a receiver configured to receive a transmitted signal from a remote transmitter, and a controller including a first processing circuitry configured to determine whether the transmitted signal is from an authorized remote operator by comparing a code in the transmitted signal to a list of codes in an authorized remote actuator list and activate the motor in response to the transmitted signal being determined to be from the authorized remote actuator list. The administration device may include a second processing circuitry configured to enable communication with the controller. The controller is further configured to delete an individual code from the authorized remote actuator list responsive to an instruction from the administration device.

The system above (and/or the opener and the administration device) may be modified in some cases. Moreover, the system, opener and administration device described above may be augmented or modified by altering individual features mentioned above or adding optional features, each of which may be combined or added in any combination. For example, the first processing circuitry may include a first memory in which the authorized remote actuator list is stored. The second processing circuitry may include a second memory in which a control list is stored. The control list may store codes corresponding to the list of codes and identification information for each corresponding remote actuator with which each respective one of the codes of the list of codes are associated. In an example embodiment, the controller may be configured to delete the individual code responsive to synchronizing the control list with the authorized remote actuator list in response to a selected remote actuator from the control list being identified for deletion at the administration device. In some cases, the controller may be configured to delete multiple codes responsive to synchronizing the control list with the authorized remote actuator list in response to more than one selected remote actuator in the control list being identified for deletion at the administration device. In an example embodiment, the second memory may be configured to also store activity information for the each corresponding remote actuator, and the second processing circuitry may be configured to enable a review of the activity information for a selected remote actuator responsive to selection of a corresponding function from an actions list displayed at the administration device. In some cases, the second processing circuitry may be configured to generate a deletion option for deleting a selected remote actuator from the control list based on selecting an event entry from the activity information and selecting the deletion option. In an example embodiment, the second processing circuitry may be configured to enable modification of the identification information of a selected remote actuator. In some cases, the identification information may include a time and date that a selected remote actuator was added to the authorized remote actuator list. In an example embodiment, the identification information may include a method via which a selected remote actuator was added to the authorized remote actuator list. In some cases, the administration device may include a remote computer, tablet or smartphone, and the second processing circuitry executes an application via which a user provides the instruction.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A system for operating a movable barrier, the system comprising:
an opener operably coupled to the movable barrier to transition the movable barrier between an open and a closed position, the opener comprising a receiver configured to receive a transmitted signal from a remote transmitter, and a controller comprising a first processing circuitry configured to determine whether the transmitted signal is from an authorized remote operator by comparing a code in the transmitted signal to a list of codes in an authorized remote actuator list and activate the motor in response to the transmitted signal being determined to be from the authorized remote actuator list; and
an administration device comprising a second processing circuitry configured to enable communication with the controller,
wherein the controller is further configured to delete an individual code from the authorized remote actuator list responsive to an instruction from the administration device.

2. The system of claim 1, wherein the first processing circuitry includes a first memory in which the authorized remote actuator list is stored, and
wherein the second processing circuitry includes a second memory in which a control list is stored, the control list storing codes corresponding to the list of codes and identification information for each corresponding remote actuator with which each respective one of the codes of the list of codes are associated.

3. The system of claim 2, wherein the controller is configured to delete the individual code responsive to synchronizing the control list with the authorized remote actuator list in response to a selected remote actuator from the control list being identified for deletion at the administration device.

4. The system of claim 2, wherein the controller is configured to delete multiple codes responsive to synchronizing the control list with the authorized remote actuator list in response to more than one selected remote actuator in the control list being identified for deletion at the administration device.

5. The system of claim 2, wherein the second memory is further configured to store activity information for each of the corresponding remote actuator, and
wherein the second processing circuitry is configured to enable a review of the activity information for a selected remote actuator responsive to selection of a corresponding function from an actions list displayed at the administration device.

6. The system of claim 5, wherein the second processing circuitry is configured to generate a deletion option for deleting a selected remote actuator from the control list based on selecting an event entry from the activity information and selecting the deletion option.

7. The system of claim 2, wherein the second processing circuitry is configured to enable modification of the identification information of a selected remote actuator.

8. The system of claim 2, wherein the identification information includes a time and date that a selected remote actuator was added to the authorized remote actuator list.

9. The system of claim 2, wherein the identification information includes a method via which a selected remote actuator was added to the authorized remote actuator list.

10. The system of claim 1, wherein the administration device comprises a remote computer, tablet or smartphone, and wherein the second processing circuitry executes an application via which a user provides the instruction.

11. A remotely operable movable barrier opener comprising:
a motor operable to transition the movable barrier between an open and a closed position;
a receiver configured to receive a transmitted signal from a remote transmitter; and
a controller comprising processing circuitry configured to determine whether the transmitted signal is from an authorized remote operator by comparing a code in the transmitted signal to a list of codes in an authorized remote actuator list and activate the motor in response to the transmitted signal being determined to be from the authorized remote actuator list,
wherein the controller is further configured to delete an individual code from the authorized remote actuator list responsive to an instruction from an administration device in communication with the controller.

12. The opener of claim 11, wherein the administration device is communicatively operably coupled to the opener to provide the instruction wirelessly.

13. The opener of claim 11, wherein the processing circuitry includes a first memory in which the authorized remote actuator list is stored, and
wherein the administration device comprises second processing circuitry that includes a second memory in which a control list is stored, the control list storing codes corresponding to the list of codes and identification information for each corresponding remote actuator with which each respective one of the codes of the list of codes are associated.

14. The opener of claim 13, wherein the controller is configured to delete the individual code responsive to synchronizing the control list with the authorized remote actuator list in response to a selected remote actuator from the control list being identified for deletion at the administration device.

15. The opener of claim 13, wherein the controller is configured to delete multiple codes responsive to synchronizing the control list with the authorized remote actuator list in response to more than one selected remote actuator in the control list being identified for deletion at the administration device.

16. An administration device comprising:
a user interface;
a wireless communication module communicatively operably coupling the administration device to a controller of an opener of a movable barrier; and
processing circuitry configured to provide an instruction to the controller to delete an individual code from an authorized remote actuator list stored at the controller responsive to identification of a selected remote actuator from a control list stored at the administration device and provide a deletion option presented at the user interface.

17. The administration device of claim 16, wherein the administration device comprises a remote computer, tablet or smartphone, and wherein the processing circuitry executes an application via which a user provides the instruction.

18. The administration device of claim 16, wherein the processing circuitry comprises a memory storing activity information for a plurality of remote actuators authorized to operate the opener, and
wherein the processing circuitry is configured to enable a review of the activity information for a selected remote actuator responsive to selection of a corresponding function from an actions list displayed at the user interface.

19. The administration device of claim 18, wherein the processing circuitry is configured to generate the deletion option for deleting a selected remote actuator based on selecting an event entry from the activity information and selecting the deletion option.

20. The administration device of claim 16, wherein the processing circuitry is configured to enable modification of identification information of a selected remote actuator provided in the control list.
